(19) United States
(12) Patent Application Publication
(10) Pub. No.: US 2004/0026641 A1
(43) Pub. Date: Feb. 12, 2004

(54) Cylinder apparatus

(76) Inventors: Chin-Jen Chen, Changhua Hsien (TW); Shui-Yen Lu, Yuan Lin Hsien (TW); Ming-Yuan Chen, Ping Tung City (TW); Yi-Jen Chen, Taipei (TW)

Correspondence Address: HARNESS, DICKEY & PIERCE, P.L.C., P.O. BOX 828, BLOOMFIELD HILLS, MI, 48303, US

(21) Appl. No.: 10/213,898

(22) Filed: Aug. 6, 2002

(51) Int. Cl. F16K 31/122

(52) U.S. Cl. 251/63.5

(57) ABSTRACT

A cylinder apparatus having a container whose inner space is divided into two space section by a piston, each space section having an opening for installing a tube, respectively, a needle valve installed on the tube for adjusting air pressure of the space section, and a door connected to the piston via a rod, is described. The moving speed of the door is identical to that of the piston.

### BACKGROUND OF THE INVENTION

1. Field of Invention

The present invention relates to a cylinder apparatus. More particularly, the present invention relates to cylinder apparatus application for controlling the door of semiconductor equipment chamber.

2. Description of Related Art

Yield improvement plays an important role in semiconductor manufacturing. A huge amount of resources and money is invested in yield improvement and maintenance because increments in yield reduce manufacturing costs.

Particle issue is one of the reasons for low yield in semiconductor wafers because many defects in devices are caused by particles. A device may suffer from destroyed structure, leakage, and malfunction because of particles. Consequently, different semiconductor equipment units are installed in different classes of clean room according to the demands of processes performed therein. In addition, particles in the chamber influence the yield directly.

There are several types of equipment units having a low pressure chamber in semiconductor fabrication. The door of the chamber is opened and closed by a cylinder apparatus, and the moving speed of door is fast and fixed. Thus, the door is easily damaged and a pressure gradient occurs. The damaged door is a particle source and convection flow caused by the pressure gradient increases particle quantity in the chamber.

### SUMMARY OF THE INVENTION

It is therefore an objective of the present invention to provide a cylinder apparatus to control the door of semiconductor equipment chamber.

In accordance with the above objective, a cylinder apparatus comprises a container whose inner space is divided into two space sections by a piston and each space section has an opening for installing a tube, respectively. A needle valve is mounted on the tube, and a door is connected to the piston via a rod. The speed of the piston is controlled by the pressure variation between the two space sections, and the speed of the door is identical to the speed of said piston.

It is another an objective of the present invention to provide a method for decreasing the particle quantity.

In accordance with another above objective, a cylinder apparatus is used to open and close a door of semiconductor equipment chamber. The cylinder apparatus comprises a container whose inner space is divided into two space sections by a piston and each space section has an opening for installing a tube respectively. A needle valve is mounted on the tube to control a piston moving speed by adjusting the pressure of input air currents. A door moving speed is controlled by connecting the piston and the door via a rod, and particle quantity is decreased by decreasing the door moving speed.

It is to be understood that both the foregoing general description and the following detailed description are examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates one preferred embodiment of this invention; and

FIG. 2 is a schematic, cross-sectional view of a cylinder apparatus according to one preferred embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

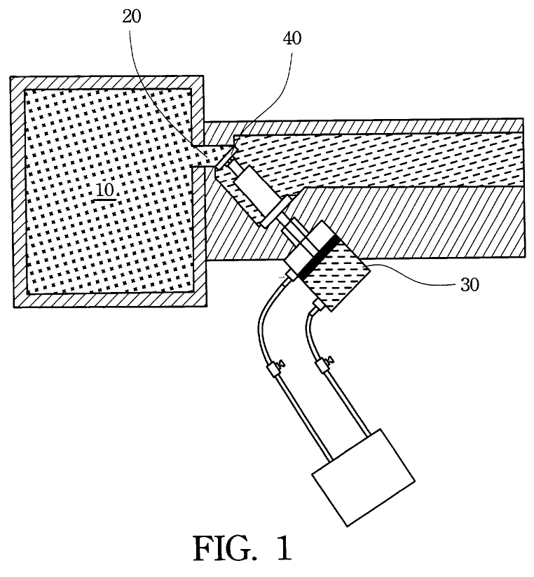

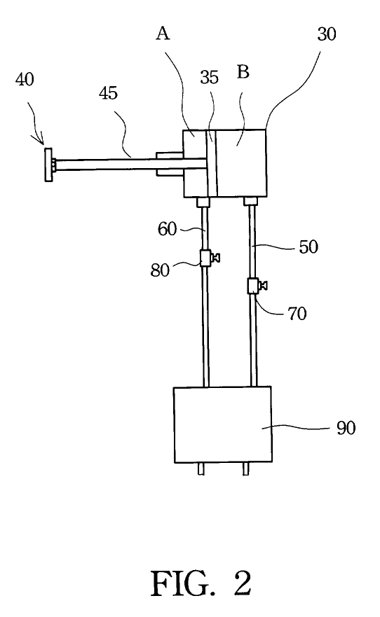

FIG. 1 illustrates one preferred embodiment of this invention. The door 40 of a wafer port 20 of process chamber 10 is opened and closed by a cylinder apparatus. FIG. 2 is a schematic, cross-sectional view of a cylinder apparatus according to one preferred embodiment of this invention. The cylinder apparatus comprises a container 30 whose inner space is divided into space section A and space section B by a piston 35. The door 40 is connected to the piston 35 via a rod 45. Each space section has an opening for installing a tube, respectively; space section A connects to the tube 60 and space section B connects to the tube 50. Both the tube 50 and tube 60 connect with electromagnetic valve 90, and the needle valve 70 and the needle valve 80 are installed in tube 50 and tube 60, respectively, between the container 30 and the electromagnetic valve 90.

As in FIG. 2, when the door 40 needs to be opened, the electromagnetic valve 90 introduces air currents into tube 60, and ignores the tube 50. Because air currents are introduced, the pressure of the space section A is higher than that of the space section B. The door 40 is opened as the piston 35 moves towards to the right.

As in FIG. 2, when the door 40 needs to be closed, the electromagnetic valve 90 introduces air currents into tube 50, and ignores the tube 60. Because air currents are introduced, the pressure of the space section B is larger than that of the space section A. The door 40 is closed as the piston 35 moves towards to the left.

In view of the operation theory described above, the moving speed of door 40 is proportional to the pressure variation between the space section A and the second space section B. The pressure variation between two space section is controlled by a needle valve. When the door 40 needs to be opened, the pressure of the space section A is controlled by the needle valve 80. When the door 40 needs to be closed, the pressure of the space section B is controlled by the needle valve 70.

In conclusion, the cylinder apparatus of present invention has the ability to control the door speed so as to prevent particle issue by a damaged door. Further, door speed control can prevent a pressure gradient caused by a door moving overly fast. Thus, particle quantity in the chamber decreases because the convection flow caused by pressure gradient decreases. All above advantages can increase the yield by decreasing particle quantity in the chamber.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A cylinder apparatus, applied to open and close the door of a semiconductor equipment unit chamber, said cylinder apparatus comprising a container having an inner space divided into a first space section and a second space section by a piston and each space section having a first opening and a second opening for installing a tube, respectively, another third opening being on said first space section, said cylinder apparatus comprising:
a needle valve mounted on the tube; and
a door connected to said piston via a rod through said third opening, wherein a speed of said piston is controlled by a pressure variation between said first space section and said second space section, and a speed of said door is identical to the speed of said piston.

2. The apparatus of claim 1, wherein said needle valve is mounted on the two tubes simultaneously or two needle valves are mounted on the two tubes.

3. The apparatus of claim 2, wherein said needle valve is mounted between said container and electromagnetic valve.

4. The apparatus of claim 1, wherein when a pressure of said first space section is larger than that of said second space section, said door is opened.

5. The apparatus of claim 4, wherein the speed of said door is proportional to the pressure variation between said first space section and said second space section.

6. The apparatus of claim 5, wherein the pressure variation between said first space section and said second space section is controlled by the needle valve.

7. The apparatus of claim 1, wherein when a pressure of said second space section is higher than that of first space section, then said door is closed.

8. The apparatus of claim 7, wherein the speed of said door is proportional to the pressure variation between said first space section and said second space section.

9. The apparatus of claim 8, wherein the pressure variation between said first space section and said second space section is controlled by the needle valve.

10. A method for decreasing particle quantity in a chamber, a cylinder apparatus being used to open and close a door of semiconductor equipment chamber, wherein the cylinder apparatus comprises a container having an inner space divided into two space sections by a piston, each space section has an opening for installing a tube. respectively, and a needle valve is mounted on said tube, said method comprising:
using said needle valve to control a piston moving speed by adjusting a pressure of input air currents;
controlling a door moving speed by connecting said piston and said door via a rod; and
decreasing particle quantity by decreasing said door moving speed.
